(19) United States
(12) Patent Application Publication
(10) Pub. No.: US 2025/0187097 A1
(43) Pub. Date: Jun. 12, 2025

(54) RAPID ELECTRO-GAS WELDING METHOD WITH SWING ARC, AND WELDING TORCH THEREWITH AND APPLICATION THEREOF

(71) Applicants: JIANGSU UNIVERSITY OF SCIENCE AND TECHNOLOGY, Jiangsu (CN); INSTITUTE OF SHANGHAI SPECIAL EQUIPMENT SUPERVISION AND INSPECTION TECHNOLOGY RESEARCH, Shanghai (CN)

(72) Inventors: Jiayou WANG, Jiangsu (CN); Wei WANG, Shanghai (CN); Jie ZHU, Jiangsu (CN); Tianwei WANG, Jiangsu (CN); Biao WANG, Jiangsu (CN)

(73) Assignees: JIANGSU UNIVERSITY OF SCIENCE AND TECHNOLOGY, Jiangsu (CN); INSTITUTE OF SHANGHAI SPECIAL EQUIPMENT SUPERVISION AND INSPECTION TECHNOLOGY RESEARCH, Shanghai (CN)

(21) Appl. No.: 18/844,388

(22) PCT Filed: Jan. 17, 2023
(86) PCT No.: PCT/CN2023/072541

§ 371 Date: Sep. 6, 2024

(30) Foreign Application Priority Data
Mar. 7, 2022 (CN) 202210213797.8
Aug. 30, 2022 (CN) 202211060209.8

(51) Int. Cl. B23K 9/133

(52) U.S. Cl. CPC B23K 9/1336

(57) ABSTRACT

A device is applied to a rapid electro-gas welding method, which includes enabling a welding wire to extend out from a center hole of a large-angle bent conductive rod mechanism after passing through an arc swing mechanism to form an included angle between the welding wire and a groove center line of a narrow groove to be welded, driving an arc of the welding wire to perform a front and rear linear oscillating along a plate thickness direction and a left-right circular-arc swing around a welding torch center line in the narrow groove, and driving the welding torch, a water-cooled copper slider and the welding torch oscillating mechanism to move upwards together at a welding speed to enable a molten pool to be forced to solidify implementing the rapid electro-gas welding through a swing arc with a variable amplitude and a variable frequency in the narrow groove to be welded.

### TECHNICAL FIELD

The present disclosure belongs to the technical field of welding, and specifically relates to a swing arc rapid electro-gas welding method with variable arc swing angle and arc swing frequency and a welding torch therewith and an application thereof.

### RELATED ART

Electro-gas welding is an on-site vertical arc welding technology with large welding heat input and forced weld forming in a single pass. During welding, a water-cooled copper slider is provided on the face side of the groove, and a water-cooled copper backing or a ceramic backing is provided on the back side of the groove. Compared with large groove multi-layer multi-pass arc welding, the electro-gas welding increases the welding efficiency by more than 5 to 10 times. It is increasingly utilized in the on-site vertical welding for the large assemblage of the ship segments and the construction of the large oil and gas storage tanks. During electro-gas welding of the thick steel plates, the welding torch is required to drive the arc to oscillate along the plate thickness direction to prevent the incomplete fusions at the root and the face side of the groove; and a large V-shaped groove is currently adopted to increase the penetration of the sidewalls of the groove by increasing the welding heat input, but this can easily lead to the problems of the coarse welded joint microstructure and the insufficient low-temperature toughness margin.

Chinese invention patent with the US201110376873.9 entitled “Welding gun oscillating device for vertical electro-gas welding”, which drives the screw through the motor and the synchronous wheel to propel the welding gun, so that the arc at the end of the welding wire oscillates in a zigzag shape between the left and right sidewalls of the groove, which improves the fusion at the sidewalls of the welding seam, whereas the disadvantage of the device is that when the entire welding torch oscillates between the left and right sidewalls of the groove, the arc oscillating amplitude along the width direction of the groove is little, so that the effect of the improvement on the fusion of the groove sidewalls is non-obvious. Chinese invention patent with US202110409199.3 entitled “a variable oscillating twin-wire electro-gas welding device and a novel method”, which drives a welding gun through a linkage mechanism to enable the twin-wire electro-gas welding arc not only to oscillate linearly along the direction of the plate thickness, but also to rotate in the oscillating plane, so that the flow of the molten pool is promoted, and the formation of the welding seam between the root and the face of the groove is improved, whereas the disadvantage of the device is that since the welding wire oscillates parallel to both sides of the groove, the arc cannot directly heat the sidewalls, so that the effect of the improvement on the fusion of the groove sidewalls is non-obvious. In addition, the common disadvantages of the above two devices are that the large V-shaped groove is adopted, so that the filling amount of the welding wire is large, the welding speed is relatively slow, the welding heat input is large and the low-temperature toughness margin of the joint is insufficient.

Chinese invention patent with US201810318532.8 entitled “a narrow gap vertical electro-gas welding method with low heat input” which adopts an I-shaped groove of 10 mm to 14 mm, and bends the welding wire through a gear, so that the arc at the end of the welding wire is oscillated back and forth laterally between both sidewalls of the groove, which reduces the welding heat input, improves the fusion on the groove sidewalls, and increases the welding efficiency (welding speed). However, the problems such as the irregular lateral oscillating of the welding wire, small oscillating amplitude, and poor controllability of the oscillating parameters exist, which has difficulty to stably obtain the sufficient penetration of the groove sidewalls.

### SUMMARY OF INVENTION

The objectives of the present disclosure are to eliminate the problems and the disadvantages in the prior art, provided in the present disclosure are a swing arc rapid electro-gas welding method with simple welding torch structure, rapid welding speed, low heat input, good sidewall fusion, high joint performance, strong practicability, and variable parameters, as well as a welding torch thereof, which are applied to the single-wire and twin-wire electro-gas welding.

In order to achieve the above objectives of the present disclosure, the following technical solutions are adopted in the present disclosure.

Provided is a rapid electro-gas welding method with a swing arc, and a welding torch applied to the method includes a large-angle bent conductive rod mechanism 1 and an arc swing mechanism 2, the method includes following steps.

\textcircled{1} A welding wire 3 is extended out from a center hole at a lower end of the large-angle bent conductive rod mechanism 1 after passing through the arc swing mechanism 2 to form an included angle θ between the welding wire 3 and a groove center line 15 of a narrow groove to be welded 9 through the large-angle bent conductive rod mechanism 1 of the welding torch with a bent angle of β.

\textcircled{2} An arc 6 at an end of the welding wire 3 is driven by the welding torch to perform a front and rear linear oscillating 11 along a plate thickness direction in the narrow groove to be welded 9 through the welding torch oscillating mechanism 14, while the arc swing mechanism 2 in the welding torch is driven by the arc motion controller 13 to rotate the large-angle bent conductive rod mechanism 1 to drive the arc 6 to perform a left and right circular-arc-shaped swing 10 around a welding torch center line 2a, so that an arc swing angle is adapted to a gap variation between front and back sides of the narrow groove to be welded 9, and the arc 6 is swung faster or is continued to be swung at a same frequency during a time when the arc 6 oscillates to a front part and/or a rear part of the narrow groove to be welded 9 for staying.

\textcircled{3} The welding torch, a water-cooled copper slider 5 and the welding torch oscillating mechanism 14 are driven by a dragging mechanism to move upwards together at a welding speed V_{w} to enable a molten pool 7 to be forced to solidify and form under an action of a backing 8 and the water-cooled copper slider 5, so that the rapid electro-gas welding is implemented through an swing arc with a variable amplitude and a variable frequency in the narrow groove to be welded 9.

Preferably, the bent angle β of the large-angle bent conductive rod mechanism 1 is satisfied 30°≤β≤90°, and a swing frequency of the arc 6 is adjustable in a range from 2 Hz to 30 Hz.

Preferably, when the narrow groove to be welded 9 is a V-shaped narrow groove 904, the arc 6 is performed a variable amplitude and constant frequency swing with larger arc swing angles at the front part of groove and smaller arc swing angles at the rear part of groove, and constant arc swing frequency, or the arc 6 is performed a variable amplitude and variable frequency swing with larger arc swing angles at the front part of groove and smaller arc swing angles at the rear part of groove, and larger arc swing frequency during the time when the arc 6 stays at the front part and/or the rear part of groove; when the narrow groove to be welded 9 is an I-shaped narrow gap groove 901 or a U-shaped bottom narrow gap groove 902 or a V-shaped bottom narrow gap groove 903 or a V-shaped narrow groove 904, and under the condition of a constant arc swing angle, the arc 6 is performed a constant amplitude and constant frequency swing with a constant arc swing frequency, or the arc 6 is performed a constant amplitude and variable frequency swing with a larger arc swing frequency during the time when the arc 6 stays at the front part and/or the rear part of the groove.

Preferably, a groove gap width G of the I-shaped narrow gap groove 901 or the U-shaped bottom narrow gap groove 902 or the V-shaped bottom narrow gap groove 903 ranges from 11 mm to 14 mm, a slope angle on one side of the groove ranges from 0° to 2°, and an arc swing angle of constant amplitude swing is adjustable in a range from 3° to 15°; a root gap width g of the V-shaped narrow groove 904 ranges from 8 mm to 10 mm, and a slope angle on one side of the V-shaped narrow groove ranges from 5° to 13°, the arc swing angle is adjustable in a range from 4° to 16° during a constant amplitude swing, and the arc swing angle is adjustable in a range from 7° to 32° during a variable amplitude swing.

Preferably, in Step \textcircled{1}, the included angle θ formed by the welding wire 3 and the groove center line 15 of the narrow groove to be welded 9 is equal to θ₁, where 70°≤θ₁≤90°.

Preferably, in Step \textcircled{2}, during the time when the arc 6 is driven by the welding torch to oscillate to the front part of the groove for staying, the included angle θ formed by the welding wire 3 and the groove center line 15 of the narrow groove to be welded 9 is enabled to be equal to θ₂ through the welding torch oscillating mechanism 14, where 90°≤θ₂≤110°, when the arc 6 is driven by the welding torch to oscillate to other positions in the groove or during the time when the arc 6 is driven by the welding torch to oscillate to the rear part of the groove for staying, the included angle θ formed by the welding wire 3 and the groove center line 15 of the narrow groove to be welded 9 is enabled to be equal to θ₃ through the welding torch oscillating mechanism 14, where 70°≤θ₃≤90°.

In order to achieve the above objectives of the present disclosure, another technical solution is adopted in the present disclosure.

Further provided is a welding torch applied to the rapid electro-gas welding method with the swing arc. The welding torch includes the large-angle bent conductive rod mechanism 1 and the arc swing mechanism 2, the arc swing mechanism 2 includes a hollow shaft motor 201, or an ordinary motor 206 with a transmission pair 207, the bent angle of the large-angle bent conductive rod mechanism 1 is β, where 30°≤β≤90°; an upper end of the large-angle bent conductive rod mechanism 1 is fixedly connected to a front extending shaft of the hollow shaft motor 201 through a connecting mechanism 202, or fixedly connected to a driven wheel of the transmission pair 207 of the ordinary motor 206, and is connected to a welding cable 204 through a cable connector 203, the welding wire 3 fed by a wire feeder 4 is extended out obliquely from a center hole of the large-angle bent conductive rod mechanism 1 after passing through the hollow shaft of the hollow shaft motor 201 or the driven wheel of the transmission pair 207.

Further, the large-angle bent conductive rod mechanism 1 includes a large-angle bent conductive rod 1a and a straight contact tip 1b fixedly connected at the lower end of the large-angle bent conductive rod 1a, or includes a straight conductive rod 1c and a large-angle bent contact tip 1d fixedly connected at the lower end of the straight conductive rod 1c.

Preferably, the upper end of the large-angle bent conductive rod 1a or the upper end of the straight conductive rod 1c is provided with a connecting flange, and is fixedly connected at a T-shaped end of a T-shaped extending shaft of the hollow shaft motor 201 through the connecting flange.

Preferably, a bent angle β of the large-angle bent conductive rod 1a or the large-angle bent contact tip 1d is 30° or 45° or 60°.

Further, a bent length L of the lower part of the large-angle bent conductive rod mechanism 1 ranges from 40 mm to 50 mm, and a length L₁ of the straight contact tip 1b ranges from 20 mm to 30 mm, or a bent length L₂ of the lower part of the large-angle bent contact tip 1d ranges from 20 mm to 45 mm.

Further, the welding torch further includes a detection mechanism 205 configured to detect the arc swing frequency and an arc swing midpoint, and the detection mechanism 205 is a rotary photoelectric encoder or a photoelectric switch device or an electromagnetic switch device, a rotating component in the detection mechanism 205 is sleeved on the rear extending shaft of the hollow shaft motor 201 or the ordinary motor 206, or is sleeved on a conductive rod at an upper end of the large-angle bent conductive rod mechanism 1 fixedly connected to the driven wheel of the transmission pair 207.

Preferably, the photoelectric switch device includes a grating disk 205a and a photoelectric switch 205b, and a circular-arc motion radius of a light path projection point O₁ of the photoelectric switch in a plane of the grating disk 205a is r, then r denotes an operation radius of the grating disk, where

$$r > \frac{d}{2 sin \frac{α}{2}} ,$$

d denotes a light-transmitting groove width of the grating disk, and a denotes an arc swing angle.

In order to achieve the above objectives of the present disclosure, yet another technical solution is adopted in the present disclosure.

Further provided is an application of the welding torch applied to the rapid electro-gas welding with the swing arc. The welding torch is applied to a single-wire electro-gas welding or a twin-wire electro-gas welding, when the welding torch is applied to the single-wire electro-gas welding, the arc 6 is a single wire arc, and the welding torch is utilized as a welding torch of the single wire arc; when the welding torch is applied to the twin-wire electro-gas welding, the arc 6 is utilized as a front-wire arc, then the front-wire arc is oscillated linearly back and forth and swung reciprocally left and right, whereas the rear-wire arc is neither oscillated nor swung, and the welding torch is utilized as the welding torch of the front-wire arc; or when the welding torch is applied to the twin-wire electro-gas welding, the arc 6 is utilized as the front-wire arc and the rear-wire arc respectively, then the front-wire arc is oscillated linearly forward and backward and swung reciprocally left and right, whereas the rear-wire arc is swung reciprocally left and right but is not oscillated back and forth, and the welding torch is utilized as the welding torch of the front-wire arc and the rear-wire arc, respectively.

Compared with existing similar technologies, the main advantages and beneficial effects of the present disclosure are as follows.

1) The arc at the end of the welding wire is directly driven by the large-angle bent conductive rod mechanism to swing reciprocally in a circular-arc-shape along the groove width direction (transversely), so that the lateral swing parameters for the arc are well controllable, the directivity of the wire is strong, and the stability of the arc is well, thereby improving the direct heating effect of the arc on the groove sidewall, improving the formation of the electro-gas welding seam, and improving the engineering practicality of the electro-gas welding.

2) The adoption of the large-angle bent conductive rod mechanism increases the arc swing radius and significantly reduces the arc swing angle. On one hand, the arc swing frequency is significantly increased, and the thermal effect of the arc on the groove sidewall is enhanced. On the other hand, the welding feed cable is directly and fixedly connected to the large-angle bent conducive rod mechanism, which can implement the supply of welding power without cable wrapping in the case where the carbon brush feed mechanism is not utilized, and the large-angle bent conductive rod mechanism is directly and fixedly connected to the extending shaft of the motor in the case where the coupling is not utilized, which greatly simplifies the structure of the welding torch and improves the reliability of the welding torch. Thus, the engineering practicality is further improved.

3) Compared with the traditional electro-gas welding with the large V-shaped groove, the narrow gap or the narrow groove technology is adopted, which can significantly reduce the cross-sectional area of the groove, and reduce the filling amount of the welding wire, and increase the welding speed. Therefore, the rapid electro-gas welding is implemented while the welding heat input is significantly reduced and the low-temperature toughness of the joint is improved. Furthermore, the high heat input weldability requirements for the base metal and welding consumables are reduced, the cost of the material usage is reduced, and the promotion and the application of the electro-gas welding are promoted.

4) Under the coordination control of the arc swing and oscillating, through the variable frequency control on the arc swing, that is, the arc swing frequency is increased during the time when the arc driven by the welding torch is oscillated to the front part and rear part of the groove for staying, so that the fusion at the groove face side and root is significantly improved, the problem of the incomplete fusions at the groove face side and root that is common in engineering is avoided, and the practicality is improved.

5) In the V-shaped narrow groove, the arc swing angle (swing amplitude) is automatically adjusted through the variable amplitude control on the arc swing according to the position variation that the welding torch oscillates back and forth along the depth direction of the groove, which can adapt to the various of the V-shaped groove gap width in the depth direction of the groove. Therefore, the sufficient penetration of the groove sidewalls can be stably formed without increasing the welding heat input, thereby improving the practicality.

### BRIEF DESCRIPTION OF DRAWINGS

FIG. 1 illustrates a schematic diagram of a rapid electro-gas welding method with a swing arc and a device of the present disclosure. In the figure, 1. Large-angle bent conductive rod mechanism; 2. Arc swing mechanism; 2a. Welding torch center line; 3. Welding wire; 3a. Welding wire center line; 4. Wire feeder; 5. Water-cooled copper slider; 6. Arc; 7. Molten pool; 8. Backing; 9. Narrow groove to be welded; 9a. Groove left sidewall; 9b. Groove right sidewall; 10. Circular-arc-shaped swing; 11. Linear oscillating; 12. Conductive rod mechanism rotating back and forth; 13. Arc motion controller; 14. Welding torch oscillating mechanism; 15. Groove center line; β. Bent angle; θ. Included angle between welding wire and groove center line 15; V_{w}. Welding speed.

FIG. 2 illustrates a schematic diagram of a trajectory of a coordinated motion of an arc swing and the arc oscillating in an I-shaped narrow gap groove. In the figure, 901. I-shaped narrow gap groove; 901a. First groove left sidewall; 901b. First groove right sidewall; 10a. First arc composite motion trajectory; G. Narrow gap groove gap width.

FIG. 3 illustrates a schematic diagram of a relation between an arc swing frequency and an oscillating position of the welding torch during variable frequency swing. In the figure, f. Arc swing frequency.

FIG. 4 illustrates a schematic diagram of a U-shaped bottom narrow gap groove. In the figure, 902. U-shaped bottom narrow gap groove; 902a. Second groove left sidewall; 902b. Second groove right sidewall.

FIG. 5 illustrates a schematic diagram of a V-shaped bottom narrow gap groove. In the figure, 903. V-shaped bottom narrow gap groove; 903a. Third groove left sidewall; 903b. Third groove right sidewall.

FIG. 6 illustrates a schematic diagram of a trajectory of a coordinated motion of an arc swing and the arc oscillating in a V-shaped narrow groove. In the figure, 904. V-shaped narrow groove; 904a. Fourth groove left sidewall; 904b. Fourth groove right sidewall; 10b. Second arc composite motion trajectory; g. Root gap width.

FIG. 7 illustrates a schematic diagram of a relation between the arc swing angle and an oscillating position of the welding torch during variable amplitude swing. In the figure, a. Arc swing angle.

FIG. 8 illustrates a schematic diagram of a swing arc rapid electro-gas welding torch structure in Embodiment 1. In the figure, 201. Hollow shaft motor; 202. Connecting mechanism; 203. Cable connector; 204. Welding cable; 205. Detection mechanism.

FIG. 9 illustrates a schematic diagram of a swing arc rapid electro-gas welding torch structure in Embodiment 2. In the figure, 206. Ordinary motor; 207. Transmission pair.

FIG. 10 illustrates a schematic diagram of a large-angle bent conductive rod mechanism structure in Embodiment 1. In the figure, 1a. Large-angle bent conductive rod; 1b. Straight contact tip; L. Bent length of lower part of large-angle bent conductive rod mechanism 1; L₁. Length of straight contact tip 1b.

FIG. 11 illustrates a schematic diagram of a large-angle bent conductive rod mechanism structure in Embodiment 2. In the figure, 1c. Straight conductive rod; 1d. Large-angle bent contact tip; L₂. Bent length of large-angle bent contact tip 1d.

FIG. 12 illustrates a schematic diagram of a photoelectric switch detection. In the figure, 205a. Grating disk; 205b. Photoelectric switch; 15a. Parallel line of groove center line 15; O. Center point of grating disk; O1. Light path projection point of photoelectric switch.

FIG. 13 illustrates a schematic diagram of a relation between an operation radius of a grating disk and a width of a light-transmitting groove. In the figure, AA1. Circle-arc motion chord length of light path projection point O1 of the photoelectric switch; d. Light-transmitting groove width of grating disk; r. Operation radius of grating disk.

### DESCRIPTION OF EMBODIMENTS

The technical solutions in the embodiments of the present disclosure will be clearly and completely described below with reference to the accompanying drawings in the embodiments of the present disclosure. Obviously, the described embodiments are only some, but not all, of the embodiments of the present disclosure.

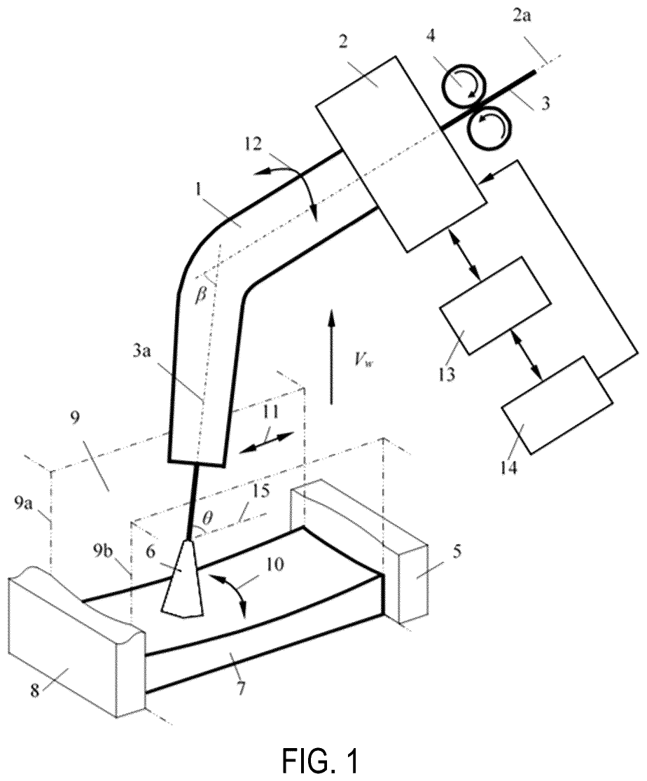

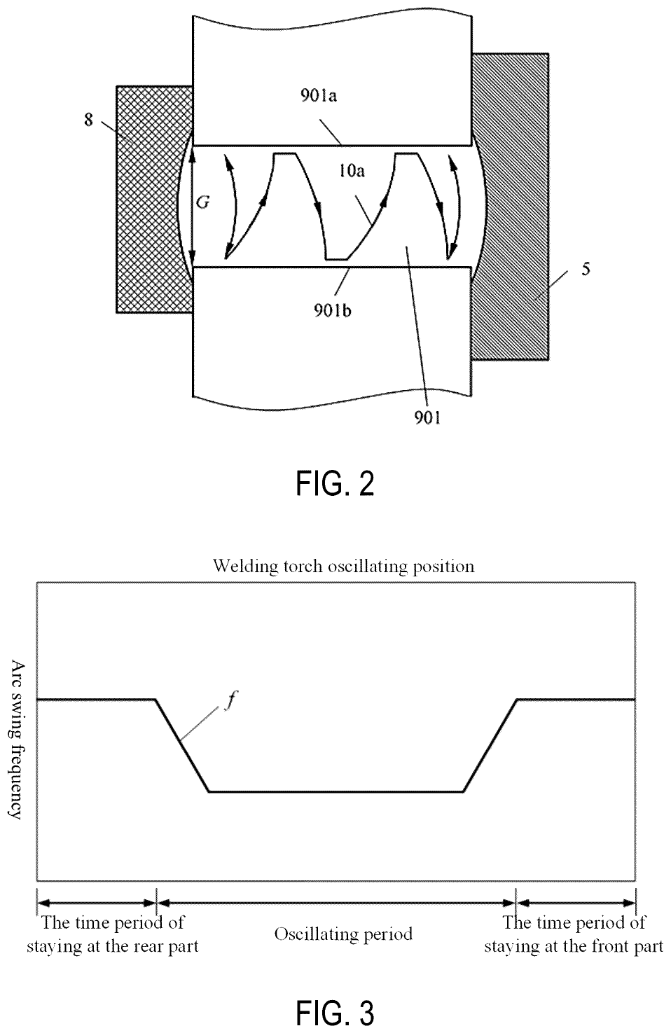

Regarding the principle of a rapid electro-gas welding method with a swing arc and a device in the present disclosure, a single-wire electro-gas welding is taken as an example, which is illustrated in FIG. 1. The device includes a welding torch of a swing arc rapid electro-gas welding, an arc motion controller 13, a welding seam forced forming device (including backing 8 and water-cooled copper slider 5, see FIG. 2 and FIGS. 4 to 6), a welding torch oscillating mechanism 14, a wire feeder 4, and further includes a common dragging mechanism (not illustrated) for dragging the welding torch, the water-cooled cooper slider 5 and the welding torch oscillating mechanism 14. The welding torch includes a large-angle bent conductive rod mechanism 1 and an arc swing mechanism 2. The arc swing mechanism 2 is connected at an upper end of the large-angle bent conductive rod mechanism 1, and a lower end of the large-angle bent conductive rod mechanism 1 is extended into a narrow groove to be welded 9 surrounded by a groove left sidewall 9a and a groove right sidewall 9b. During the welding by the non-self-protected flux-cored wire, the water-cooled copper slider 5 is provided with a welding shielding gas inlet hole to input the welding shielding gas into the welding area in the groove. The backing 8 is a ceramic backing or a water-cooled copper backing, and when the water-cooled copper backing is adopted, the water-cooled copper backing can move upwards synchronously with the welding torch. The welding wire 3 fed by the wire feeder 4 is extended out from the center hole at the lower end of the large-angle bent conductive rod mechanism 1 after passing through the arc swing mechanism 2 and the large-angle bent conductive rod mechanism 1 in sequence and is formed an included angle θ with the groove center line 15. The included angle θ is an included angle between the welding wire 3 and the groove center line 15 when the welding torch center line 2a, the welding wire center line 3a and the groove center line 15 are located on a same plane. The included angle θ is adjustable in real time according to the variation of the oscillating positions of the welding torch, and is adjustable in a range from 70° to 110°.

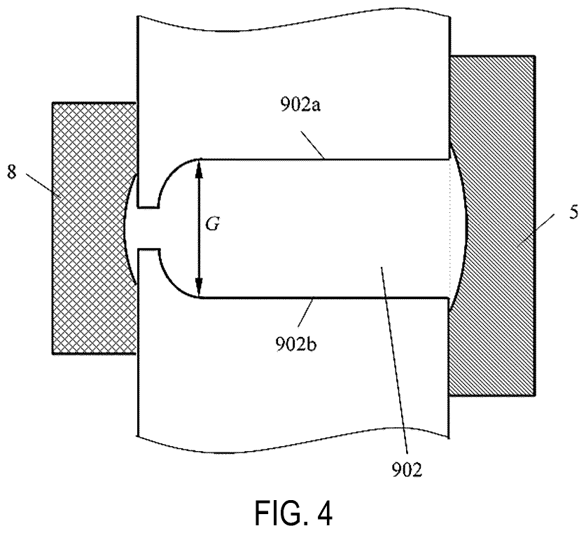

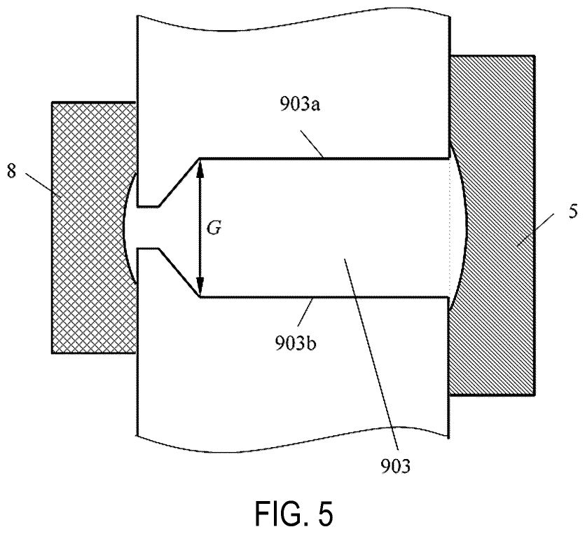

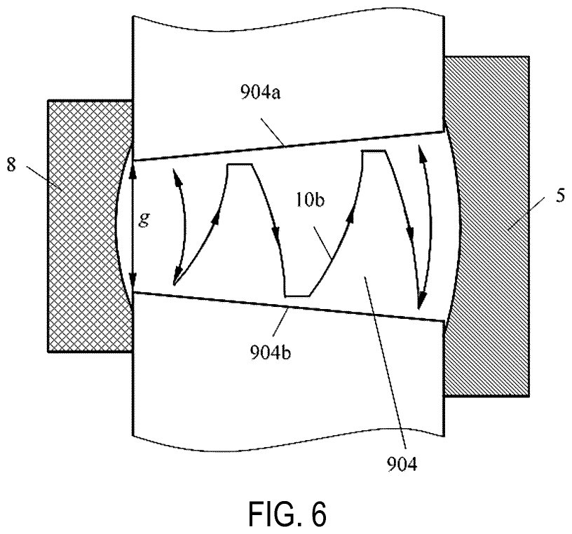

The narrow groove to be welded 9 is a single-shaped groove or a compound-shaped groove, and preferably includes a first groove shaped in an I-shaped narrow gap groove 901, a second groove shaped in a U-shaped bottom narrow gap groove 902, a third groove shaped in a V-shaped bottom narrow gap groove 903 and a fourth groove shaped in a V-shaped narrow groove 904. As illustrated in FIG. 2, the first groove shaped in the I-shaped narrow gap groove 901 is surrounded by a first groove left sidewall 901a and a first groove right sidewall 901b, and the width G of the narrow gap groove is the bottom gap width of the groove. As illustrated in FIG. 4, the second groove shaped in the U-shaped bottom narrow gap groove 902 is surrounded by a second groove left sidewall 902a and a second groove right sidewall 902b, and the width G of the narrow gap groove is the groove gap width at the intersection of the U-shaped bottom. As illustrated in FIG. 5, the third groove shaped in a V-shaped bottom narrow gap groove 903 is surrounded by a third groove left sidewall 903a and a third groove right sidewall 903b, and the width G of the narrow gap groove is the groove width at the intersection of the V-shaped bottom. And as illustrated in FIG. 6, the fourth groove shaped in the V-shaped narrow groove 904 is surrounded by a fourth groove left sidewall 904a and a fourth groove right sidewall 903b, and g denotes a root gap width of the groove. The U-shaped bottom or V-shaped bottom of the groove may not be provided with a blunt edge, and the back of the V-shaped narrow groove 904 may also be provided with a blunt edge. The groove area near the face water-cooled copper slider 5 is the front part of the groove, and the groove area near the backing 8 is the rear part of the groove. Preferably, the slope angle on one side of the narrow gap groove ranges from 0° to 2°, and the slope angle on one side of the V-shaped narrow groove is not greater than 15°.

Before welding, the arc motion controller 13 is configured to set and display the arc swing parameters (arc swing frequency, arc swing angle, and the staying times when the arc swings to the left and right sides of the groove), the welding torch oscillating parameters (welding torch oscillating frequency and the staying times when the welding torch oscillates to the front and rear parts of the groove), and the arc motion controller 13 can be further cooperated with the detection mechanism to automatically find and locate the arc swing midpoint before welding. During the welding process, the arc motion controller 13 is configured to control the arc swing mechanism 2 or the welding torch oscillating mechanism 14, and can be cooperated with the detection mechanism to detect and display the arc swing frequency and the welding torch (arc) oscillating frequency in real time, and the arc swing frequency is adjustable in the range from 0 Hz to 35 Hz, the arc swing angle is adjustable in the range from 0° to 90°, the time when the arc swings to both sides of the groove for staying is adjustable in the range from 0 ms to 200 ms, respectively, the welding torch oscillating frequency is adjustable in the range from 0 Hz to 1.5 Hz, and the time when the welding torch oscillates to front and back sides of the groove for staying is adjustable in the range from 0 s to 2 s.

During welding, the welding arc 6 is ignited in the narrow groove to be welded 9, at this time, the welding current is supplied for the arc 6 through the large-angle bent conductive rod mechanism 1, then the arc motion controller 13 sends a control signal to rotate the large-angle bent conductive rod mechanism 1 through the arc swing mechanism 2 to drive the arc 6 at the end of the welding wire 3 to perform the left and right circular-arc-shaped swing 10 between the groove left sidewall 9a and the groove right sidewall 9b of the narrow groove to be welded 9, and the arc motion controller 13 sends a control signal to drive the welding torch and the arc 6 to perform the front and rear linear oscillating 11 along the depth direction of the groove through the welding torch oscillating mechanism 14, so that the arc 6 moves in coordination of the left and right circular-arc-shaped swing 10 and the front and rear linear oscillating 11, while the welding torch, the water-cooled copper slider 5 and the welding torch oscillating mechanism 14 are driven by the dragging mechanism to move upwards together at the welding speed V_{w} to enable the molten pool 7 to solidify into a welding seam under the combined action of the backing 8 and the water-cooled copper slider 5. Correspondingly, for the narrow gap groove or the V-shaped narrow groove, since the cross-sectional area of the groove becomes smaller, the welding speed can be increased, so that the swing arc rapid electro-gas welding with adjustable swing angle and swing frequency is implemented, and when the thickness of workpiece is relative thin, the arc may not oscillate linearly back and forth.

The rapid electro-gas welding method with the swing arc of the present disclosure, on one hand, can reduce the groove section by adopting the narrow gap groove or the V-shaped narrow groove, thereby significantly increasing the welding speed, reducing the welding heat input and improving the strength and toughness of the joint, while reducing the filling amount of welding wire, and implementing the low-cost and high-performance rapid electro-gas welding at a more rapid welding speed (compared with the V-shaped large groove process); on the other hand, can facilitate the fusion of the groove sidewalls through the reciprocating circular-arc-shaped swing 10 of the arc 6 between the left and right walls of the narrow groove to be welded 9, and can obtain an electro-gas welding joint with an excellent welding seam formation under the relative lower heat input, thereby facilitating the applications of the narrow gap or the narrow groove process, and further improving the strength and toughness of the joint. Therefore, the electro-gas welding method of the present disclosure can coordinatively improve the performance and the efficiency (welding speed) of electro-gas welding, reduce the weldability requirements for the large heat input of the base metal and the welding consumables, and implement the high-performance rapid electro-gas welding.

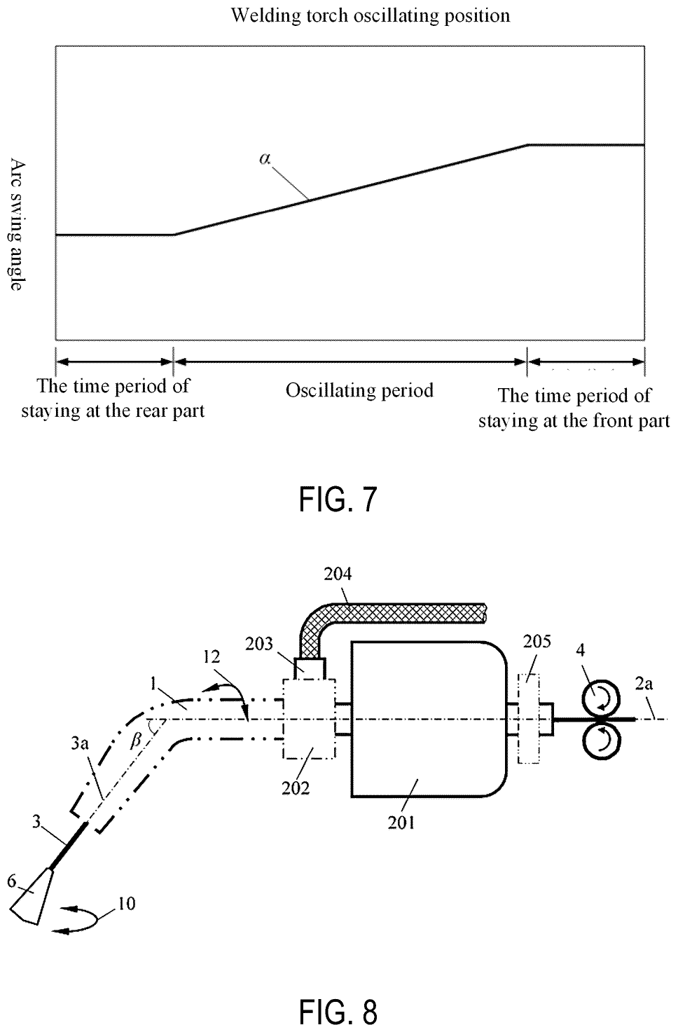

Embodiment of a coordination control of an arc swing and an arc oscillating: when the arc moves in coordination of the swing and the oscillating, on one hand, the arc 6 is performed a left and right reciprocating circular-arc-shaped swing 10 in the narrow groove 9 to be welded, and on the other hand, the welding torch is driven by the welding torch oscillating mechanism 14 to enable the arc 6 to perform a front and rear linear oscillating 11. The oscillating positions of the welding torch includes the position of the welding torch during the time of oscillating from front to rear or from rear to front, the position of the welding torch during the staying time at the rear part of the groove and the position of the welding torch during the staying time at the front part of the groove. As illustrated in FIG. 3 and FIG. 7, four arc coordinated motion modes are provided, which are as follows. When the narrow gap groove or the V-shaped narrow groove is adopted, the arc coordinate motion modes includes two modes of “constant amplitude and constant frequency swing plus linear oscillating” and “constant amplitude and variable frequency swing plus linear oscillating”, and when the V-shaped narrow groove is adopted, the arc coordinate motion mode preferably includes two modes of “variable amplitude and variable frequency swing plus linear oscillating” and “variable amplitude and constant frequency swing plus linear oscillating”.

Embodiment of “constant amplitude and constant frequency swing plus linear oscillating” mode: as illustrated in FIG. 2, in the I-shaped narrow gap groove 901, on one hand, the welding arc 6 is performed the constant amplitude circular-arc-shaped swing 10 at a constant swing angle (i.e., constant amplitude) along the width direction of the groove, on the other hand, the welding torch is driven by the welding torch oscillating mechanism 14 to enable the arc to perform the linear oscillating 11 along a depth direction of the groove, and the arc can be stayed briefly when the arc swings to the positions near the first groove left sidewall 901a and the first groove right sidewall 901b, and oscillates to the positions near the rear part of the groove (the side of backing 8), and the front part of the groove (the side of water-cooled copper slider 5), so that the sufficient fusion depth of the groove sidewall is formed by the arc heat, and correspondingly, the first arc composite motion trajectory 10a is formed in the I-shaped narrow gap groove 901. During the process that the welding torch drives the arc 6 to perform a front and rear linear oscillating 11, including the time when the arc stays at the front part and the rear part during oscillating back and forth, the swing frequency is permanently remained to be unvaried (i.e., constant frequency), so that the arc composite motion control of “amplitude constant frequency swing plus linear oscillating” is implemented, and the I-shaped narrow gap groove 901 can be replaced by the U-shaped bottom narrow gap groove 902 (see FIG. 4), or the V-shaped bottom narrow gap groove 903 (see FIG. 5), or the V-shaped narrow groove 904 (see FIG. 6) to implement the arc motion mode of “constant amplitude and constant frequency swing-plus linear oscillating”.

Embodiment of “constant amplitude and variable frequency swing plus linear oscillating” mode: as illustrated in FIG. 2, in the I-shaped narrow gap groove 901, during the process that the welding torch drives the arc 6 to perform a front and rear linear oscillating 11, the arc swing angle is remained to be unvaried (i.e., constant amplitude), while the arc swing frequency f is increased (i.e., variable frequency) during the time when the welding torch is oscillated to the front and/or rear part of the groove for staying, which is as illustrated in FIG. 3. In such a way, in the I-shaped narrow gap groove, the arc 6 is performed the constant amplitude and variable frequency swing, in which the arc swing frequency is large during the time when the arc stays at the front part of the groove, or during the time when the arc stays at the rear part of the groove, or during the time when the arc stays at the front and rear parts of the groove, while enabling the arc swing angel to be unvaried, to implement the control on the arc composite motion of “constant amplitude and variable frequency swing plus linear oscillating”. That is to say, during the time when the arc is driven by the welding torch to oscillate to the front part and rear part of the groove for staying, the arc 6 is swung rapidly through the arc swing mechanism 2 to increase the arc heat input to both sidewalls of the groove and improve the uniformity of the arc heat distributed on both sidewalls of the groove, so that the root of groove and the face side of groove can be fused completely to improve the practicality, and the I-shaped narrow gap groove 901 can be replaced by the U-shaped bottom narrow gap groove 902 (see FIG. 4), or the V-shaped bottom narrow gap groove 903 (see FIG. 5), or the V-shaped narrow groove 904 (see FIG. 6) to implement the arc motion mode of “constant amplitude and variable frequency swing plus linear oscillating”.

Embodiment of “variable amplitude and variable frequency swing plus linear oscillating” mode: as illustrated in FIG. 6, in the V-shaped narrow groove 904, during the process that the welding torch drives the arc 6 to perform a front and rear linear oscillating 11, the arc 6 is swung left and right with a variable amplitude between the fourth groove left sidewall 904a and the fourth groove right sidewall 904b by the arc motion controller 13 through the arc swing mechanism 2 according to the position variation that the welding torch oscillates back and forth, that is, when the welding torch is close to the face side of the groove, the arc swing angle α (swing amplitude) is increased, and when the welding torch is close to the root of the groove, the arc swing angle α is decreased, which is illustrated in FIG. 7, and correspondingly, the second arc composite motion trajectory 10b is formed in the V-shaped narrow groove 904; meanwhile, during the time when the arc stays at the front part and/or the rear part of the groove during the welding torch oscillates back and forth, the arc swing frequency f is increased while the arc swing angle α is remained to be unvaried (see FIG. 3). In such a way, in the V-shaped narrow groove, the arc 6 is performed the variable amplitude and variable frequency swing, in which the arc swing angle α is larger at the front part of the groove and smaller at the rear part of the groove, and the arc swing frequency f is large during the time when the arc stays at the front part of the groove, or the time when the arc stays at the rear part of the groove, or the time when the arc stays at the front part and rear part of the groove to implement the control on the arc composite motion of “variable amplitude and variable frequency swing plus linear oscillating”.

Embodiment of “variable amplitude and constant frequency swing plus linear oscillating” mode: as illustrated in FIG. 6 and FIG. 7, on the basis of the variable amplitude swing in the embodiment of “variable amplitude and constant frequency plus linear oscillating” mode, during the arc 6 is driven by the welding torch to perform the front and rear linear oscillating 11 in the V-shaped narrow groove 904, including the time when the arc stays at the front part and the rear part of the groove during the welding torch oscillates back and forth, the arc swing frequency f is permanently remained to be unvaried (constant frequency). In such a way, in the V-shaped narrow groove, the arc 6 is performed the variable amplitude and constant frequency swing, in which the arc swing angle α is larger at the front part of the groove and smaller at the rear part of the groove, and with the constant arc swing frequency f to implement the control on the arc composite motion of “variable amplitude and constant frequency swing plus linear oscillating”.

Embodiment of a method for adjusting the included angle θ between the welding wire and the groove center line in real time: in order to improve the accessibility of the arc 6 in the narrow groove to be welded 9 and further improve the fusions at the root and face sides of groove, on one hand, through the swing parameters setting before welding, the included angle θ between the welding wire 3 and the groove center line 15 is enabled to be equal to θ₃, where θ₃≤90°, and preferably 70°≤θ₃≤90°, during the time when the welding torch oscillates from front to rear or from rear to front of the groove, and the time when the welding torch stays at the rear part of the groove, so that the effect of the arc 6 directly heating on the rear part of groove is enhanced when the arc 6 is driven by the welding torch to oscillate to position near the back side of the groove, thereby further improving the fusion of the groove root. On the other hand, during the time when the welding torch drives the arc 6 to oscillate to the front part of the groove for staying, the welding torch is rotated at a certain angle in the oscillating plane by the welding torch oscillating mechanism 14, so that the included angle θ between the welding wire 3 and the groove centerline 15 is enabled to be equal to θ₂, where θ₂≥90°, and preferably 90°≤θ₂≤110°, at this time, the arc 9 is more close to the groove face side, which can strengthen the effect of the arc directly heating on the front part of the groove to further improve the fusion on the face side of the groove. The values for θ₂ and θ₃ are selected within the range of the above-mentioned preferred parameters, according to the values for the welding arc current, arc voltage, and the amplitude of the welding torch oscillating back and forth.

Embodiment 1 of a welding torch for the swing arc rapid electro-gas welding: as illustrated in FIG. 1 and FIG. 8, the welding torch includes a large-angle bent conductive rod mechanism 1, an arc swing mechanism 2, a connecting mechanism 202, and a cable connector 203, the welding cable 204, or further includes a detection mechanism 205 configured to detect the arc swing frequency and the arc swing midpoint. The arc swing mechanism 2 includes a hollow shaft motor 201, and the hollow shaft motor 201 is a DC motor or a stepper motor or a servo motor with a hollow shaft. When the upper end of the large-angle bent conductive rod mechanism 1 is a straight end, the connecting mechanism 202 is preferably a nut-type connector, and when the upper end of the large-angle bent conductive rod mechanism 1 is provided with a connecting flange, the connecting mechanism 202 is a flange connector formed by the connecting flange and the T-shaped end of the front extending shaft of the hollow shaft motor 201. The upper end of the large-angle bent conductive rod mechanism 1 is fixedly connected to the front extending shaft of the hollow shaft motor 201 through the nut-type connector, or the upper end of the large-angle bent conductive rod mechanism 1 is fixedly connected to the T-shaped end of the front extending shaft of the hollow shaft motor 201 through the flange connector. One end of the welding cable 204 is connected to the welding power supply, and the other end of the welding cable 204 is fixedly connected to the connecting mechanism 202 through the cable connector 203, or directly and fixedly connected to the large-angle bent conductive rod mechanism 1.

After the welding wire 3 is fed from the wire feeder 4, the welding wire 3 is extended out obliquely after sequentially passing through the hollow shaft of the hollow shaft motor 201 and the center hole at the lower end of the large-angle bent conductive rod mechanism 1. An included angle β is formed by the welding wire center line 3a extending obliquely and the welding torch center line 2a, and the included angle β is the bent angle of the large-angle bent conductive rod mechanism 1, which can be valued in the range from 15° to 90°. In order to facilitate the manufacturing of the large-angle bent conductive rod mechanism 1, the included angle β is preferably valued as 30° or 45° or 60°. The large-angle bent conductive rod mechanism 1 is driven by the hollow shaft motor 201 through the connecting mechanism 202, such that the conductive rod mechanism rotates back and forth 12 around the welding torch center line 2a to drive the arc 6 at the end of the welding wire 3 to perform the circular-arc-shaped swing 10, thereby implementing the arc swing for the electro-gas welding.

In addition, the welding torch further includes a detection mechanism 205 configured to detect the arc swing frequency and the arc swing midpoint. In this case, the detection mechanism 205 is a rotary photoelectric encoder or a photoelectric switch device or an electromagnetic switch device, and preferably, a rotating component of the detection mechanism 205 is sleeved on the rear extending shaft of the hollow shaft motor 201. When the hollow shaft motor 201 is a servo motor, the detection mechanism 205 may not be provided, but the arc swing frequency and the arc swing midpoint can be detected directly through the built-in photoelectric encoder of the servo motor. Correspondingly, the midpoint positioning of the arc swing can be detected and automatically searched by the arc motion controller 13 in the electro-gas welding device (see FIG. 1) before welding, and the arc swing frequency can be detected and displayed in real time during welding, according to the rotation position signal sent by the detection mechanism 205 or the built-in photoelectric encoder of the servo motor.

Since the large-angle bent conductive rod mechanism 1 is adopted in the welding torch of the rapid electro-gas welding with a swing arc in the present disclosure, the arc swing radius is increased and the arc swing angle α is significantly reduced, so that on one hand, the arc swing frequency is significantly improved and the thermal action of the arc on the sidewalls of the groove is enhanced, and on the other hand, the welding cable 204 is directly and fixedly connected to the large-angle bent conductive rod mechanism 1, and the supply of welding power without cable wrapping is implemented with no utilization of the carbon brush feed mechanism. And since the carbon brush feed mechanism is not utilized, the large-angle bent conductive rod mechanism 1 can be directly and fixedly connected to the extending shaft of the motor without using a coupling. In such a way, the structure of the welding torch is significantly simplified, and the operation reliability and the engineering practicality of the welding torch are improved.

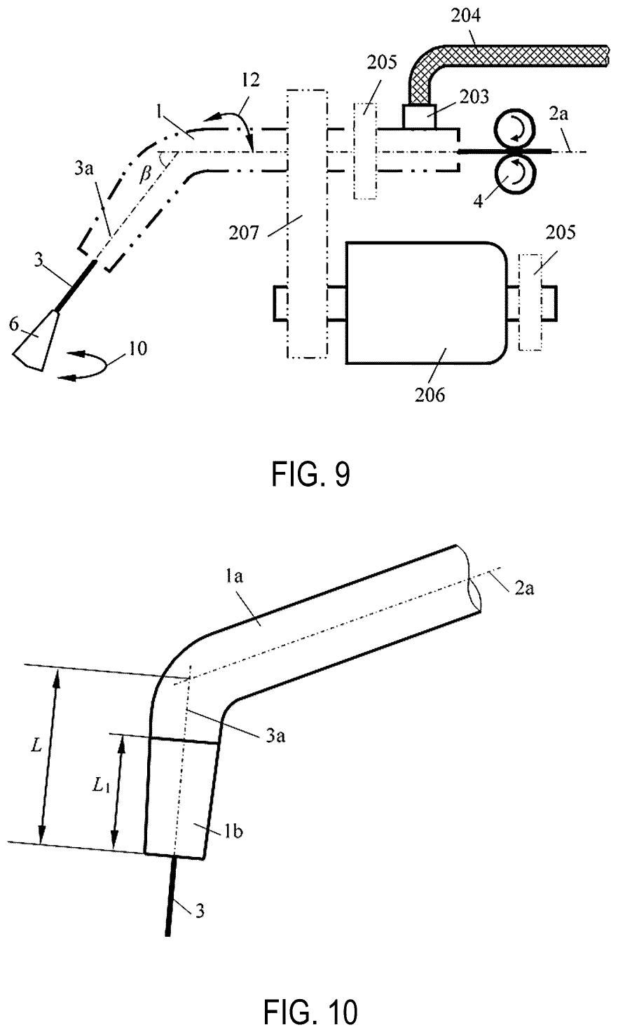

Embodiment 2 of a welding torch for the swing arc rapid electro-gas welding: as illustrated in FIG. 1 and FIG. 9, the welding torch includes a large-angle bent conductive rod mechanism 1, an arc swing mechanism 2, a cable connector 203, and a welding cable 204, or further includes a detection mechanism 205 configured to detect the arc swing frequency and the arc swing midpoint. The arc swing mechanism 2 includes a commercially available ordinary motor 206 and a transmission pair 207. The ordinary motor 206 is a DC motor or a stepper motor or a servo motor, and the transmission pair 207 is a pulley transmission pair or a gear transmission pair. The driving wheel of the transmission pair 207 is sleeved on the front extending shaft of the ordinary motor 206, and the driven wheel of the transmission pair 207 is sleeved on the conductive rod at the upper end of the large-angle bent conductive rod mechanism 1. One end of the welding cable 204 is connected to the welding power supply, and the other end is fixedly connected to the conductive rod at the upper end of the large-angle bent conductive rod mechanism 1 through the cable connector 203, thereby implementing the supply of welding power without cable wrapping.

After the welding wire 3 is fed from the wire feeder 4, the welding wire 3 is extended out obliquely after passing through the center hole of the large-angle bent conductive rod mechanism 1, and an included angle β is formed by the welding wire center line 3a extending obliquely and the welding torch center line 2a. The included angle β is the bent angle of the large-angle bent conductive rod mechanism 1, which can be valued in the range from 15° to 90°, and preferably is valued as 30° or 45° or 60°. The driving wheel of the transmission pair 207 is driven by the ordinary motor 206 to drive the driven wheel of the transmission pair 207 and the large-angle bent conductive rod mechanism 1, such that the conductive rod mechanism rotates back and forth 12 around the center line 2a to drive the arc 6 at the end of the welding wire 3 to perform the circular-arc-shaped swing 10, thereby implementing the arc swing under the electro-gas welding.

In addition, the welding torch further includes a detection mechanism 205 configured to detect the arc swing frequency and the arc swing midpoint. In this case, the detection mechanism 205 is a rotary photoelectric encoder or a photoelectric switch device or an electromagnetic switch device, and preferably, a rotating component in the detection mechanism 205 is sleeved on the rear extending shaft of the ordinary motor 206, or on the conductive rod at the upper end of the large-angle bent conductive rod mechanism 1 that is fixedly connected to the driven wheel of the transmission pair 207. When the ordinary motor 206 is a servo motor, the detection mechanism 205 may not be provided, but the arc swing frequency and the arc swing midpoint can be detected directly through the built-in photoelectric encoder of the servo motor. Correspondingly, the midpoint positioning of the arc swing can be detected and automatically searched by the arc motion controller 13 in the electro-gas welding device (see FIG. 1) before welding, and the arc swing frequency can be detected and displayed in real time during welding according to the rotation position signal sent by the detection mechanism 205 or the built-in photoelectric encoder of the servo motor.

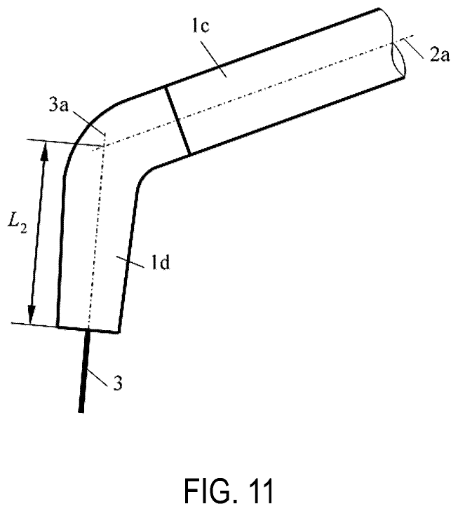

Embodiment 1 of the large-angle bent conductive rod mechanism: as illustrated in FIG. 10, the large-angle bent conductive rod mechanism 1 includes a large-angle bent conductive rod 1a and a straight contact tip 1b fixedly connected at the lower end of the large-angle bent conductive rod 1a. The welding wire 3 is preferably extended out from the center hole of the straight contact tip 1b. The large-angle bent conductive rod 1a is required to be manufactured specially, while the straight contact tip 1b can be adopted by an ordinary contact tip. The bent length L of the lower part of the large-angle conductive rod mechanism 1 can range from 40 mm to 50 mm, and Z can be valued as 45 mm, and the length L₁ of the straight contact tip 1b can range from 20 mm to 30 mm.

Embodiment 2 of the large-angle bent conductive rod mechanism: as illustrated in FIG. 11, the large-angle bending conductive rod mechanism 1 includes a straight conductive rod 1c and a large-angle bent contact tip 1d fixedly connected at the lower end of the straight conductive rod 1c. The welding wire 3 is preferably extended out from the center hole of the large-angle bent contact tip 1d. The large-angle bent contact tip 1d is adopted, which can reduce the bent length of the large-angle bent conductive rod mechanism 1, and increase the range of the arc swing angle, and improve the controllability of the arc swing. The bent length L₂ of the lower end of the large-angle bent contact tip 1d is the bent length L of the lower part of the large-angle bent conductive rod mechanism 1, and L is equal to L₂ and can range from 20 mm to 45 mm, preferably, L₂ can range from 25 mm to 35 mm, and L₂ can be valued as 25 mm or 30 mm or 35 mm, which can not only facilitate the manufacturing of large-angle bent contact tip 1d, but also increase the range of the arc swing angle as much as possible.

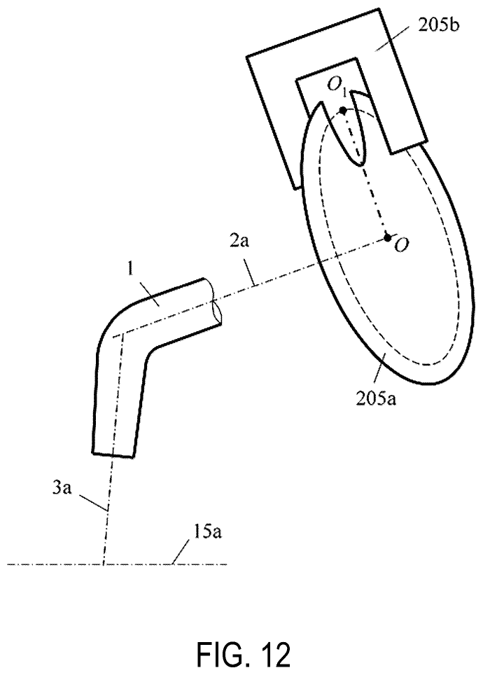

Embodiment of the detection mechanism configured to detect arc swing frequency and arc swing midpoint: when a stepper motor or a DC motor is adopted, the welding torch further includes a detection mechanism 205 configured to detect the arc swing frequency and the arc swing midpoint. The detection mechanism 205 is a rotary photoelectric encoder or a photoelectric switch device or an electromagnetic switch device. When the detection mechanism 205 is a photoelectric switch device, the photoelectric switch device includes a grating disk 205a and a photoelectric switch 205b. The detection principle of the photoelectric switch device is illustrated in FIG. 12, in which O is the center point of the grating disk 205a. When the detection mechanism 205 is configured to automatically position the arc swing midpoint, the hollow shaft motor 201 or the ordinary motor 206 is driven by the arc motion controller 13 to slowly rotate the large-angle bent conductive rod mechanism 1 until the projection point O₁ of the photoelectric switch 205b light path on the plane of the grating disk is exactly located on the U-shaped notch center line of the grating disk 205a. At this time, the welding torch center line 2a, the welding wire center line 3a and the parallel line 15a of the groove center line 15 are located on a same plane, thereby implementing the automatic positioning of the arc swing midpoint before welding.

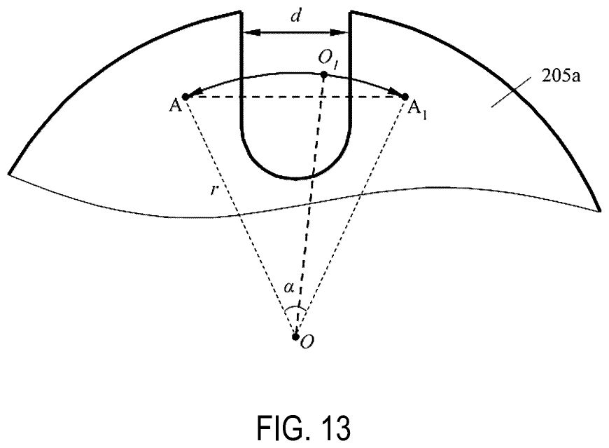

When the detection mechanism 205 is configured to detect the arc swing frequency, the arc swing frequency f is detected by the arc motion controller 13 through detecting the on/off times of the photoelectric switch 205b within a certain period when the welding wire is started to swing before welding or after the arc 6 is started to swing during welding. During the swing arc electro-gas welding, the bent angle of the conductive rod mechanism is relative large, which results in a relative small arc swing angle α. Within the range of the arc swing angle α, in order to ensure that the photoelectric switch 205b can be operated in the on/off switching state to detect the arc swing frequency in real time, a matching relation among the operation radius r of the grating disk, the light-transmitting groove width d of the grating disk, and the arc swing angle α is required to be established. As illustrated in FIG. 13, corresponding to the arc swing angle α, the extreme positions of the projection point O₁ of the light path of the photoelectric switch moving to left and right are A and A₁, at this time, in order to ensure that the on/off state of the photoelectric switch 205b can be detected, the moving chord length AA₁ of the light path projection point O₁ of the photoelectric switch is required to be greater than the light-transmitting groove width d of the grating disk. Correspondingly, the moving radius of the projection point O₁ of the light path of the photoelectric switch on the grating disk 205a is r, where r=OO₁=OA=OA₁, and r denotes the operation radius of the grating disk and satisfies the following condition:

$$r > \frac{d}{2 sin \frac{α}{2}} ,$$

Embodiment of the swing arc rapid electro-gas welding method and the application of the welding torch: the welding torch is applied to a single-wire electro-gas welding or a twin-wire electro-gas welding. When the welding torch is applied to single-wire electro-gas welding, the arc 6 is a single-wire arc, and the welding torch is utilized as a welding torch of the single-wire arc. When the welding torch is applied to the twin-wire electro-gas welding, the arc 6 is utilized as a front-wire arc, then the front-wire arc is oscillated linearly back and forth and swung reciprocally left and right, whereas the rear wire arc is neither swung nor oscillated, and the welding torch is utilized as a welding torch of the front-wire arc. Or when the welding torch is applied to the twin-wire electro-gas welding, the arc 6 is utilized as a front-wire arc and a rear-wire arc, respectively, then the front-wire arc is oscillated linearly back and forth and swung reciprocally left and right, whereas the rear-wire arc is swung reciprocally left and right but is not oscillated back and forth, and the welding torch is utilized as a welding torch of the front-wire arc and the rear-wire arc, respectively.

Embodiment of the parameters of the swing arc rapid electro-gas welding for the narrow gap groove: the single-wire electro-gas welding is taken as an example, the thickness of the workpiece plate ranges from 15 mm to 40 mm, the groove gap width G of the I-shaped narrow gap groove 901 or the U-shaped bottom narrow gap groove 902 or the V-shaped bottom narrow gap groove 903 ranges from 11 mm to 14 mm, respectively, and the slope angle on one side of the I-shaped narrow gap groove 901 or the U-shaped bottom narrow gap groove 902 or the V-shaped bottom narrow gap groove 903 ranges from 0° to 2°, respectively. The flux-cored welding wire of 1.6 mm is adopted, the welding current ranges from 300 A to 450 A, and the arc voltage ranges from 30 V to 45 V, and the welding wire extension ranges from 25 mm to 35 mm, the bent angle β of the large-angle bent conductive rod mechanism 1 is 45°, and the bent length (L or L₂) of the lower part of the large-angle curved conductive mechanism 1 ranges from 20 mm to 45 mm. The included angle θ between the welding wire 3 and the groove center line 15 of is enabled to be equal to θ₁ (70°≤θ₁≤90°), or the included angle θ is adjusted according to the real-time adjustment method described above. The arc swing frequency f ranges from 2 Hz to 30 Hz, the time when the arc swings to both sides of the groove for staying is adjustable in the range from 0 ms to 200 ms, respectively, the arc swing angle α can be selected in a range of 3° to 15° during constant amplitude swing, and the embodiments of the arc swing angle are as follows.

Embodiment 1 and embodiment 2 of the arc swing angle for the arc constant amplitude swing: the groove gap width G of the I-shaped narrow gap groove 901 or the U-shaped bottom narrow gap groove 902 or the V-shaped bottom narrow gap groove 903 is 11 mm, and the welding wire extension is 30 mm, the bent lengths (L or L₂) of the lower part of the large-angle bent conductive rod mechanism 1 are 20 mm and 45 mm, respectively, and when the arc swings to the groove sidewall for staying, the shortest distance between the center axis of the arc and the groove sidewall varies from 2.5 mm and 4.0 mm, the arc swing angle α is selected in the range of 10° to 5° and 6.5° to 3°, respectively, and the shortest distance is the reserved process gap between the arc and the groove sidewall.

Embodiment 3 and embodiment 4 of the arc swing angle for the arc constant amplitude swing: the groove gap width G of the I-shaped narrow gap groove 901 or the U-shaped bottom narrow gap groove 902 or the V-shaped bottom narrow gap groove 903 is 14 mm, and the welding wire extension is 30 mm, the bent lengths (L or L₂) of the lower part of the conductive rod mechanism 1 are 20 mm and 45 mm, respectively, and when the reserved process gap between the arc and the groove sidewall is varied from 2.5 mm to 4.0 mm, the arc swing angle α is selectable in the range of 15° to 10° and 10 to 6°, respectively.

Embodiment of the parameters for the swing arc rapid electro-gas welding process for the V-shaped narrow groove 904: the single-wire electro-gas welding is taken as an example, the thickness of the workpiece plate ranges from 15 mm to 40 mm, the root gap width g of the groove ranges from 8 mm to 10 mm, and the slope angle on one side of the groove ranges from 5° to 13°, and when the root gap width g of the groove is relative small, a relative large slope angle on one side of the groove is preferably selected. The flux-cored welding wire of 1.6 mm is adopted, the welding current ranges from 300 A to 450 A, the arc voltage ranges from 30 V to 45 V, and the welding wire extension ranges from 25 mm to 35 mm, the bent angle β of the large-angle bent conductive rod mechanism 1 is 45°, and the bent length (L or L₂) of the lower part of the large-angle bent conductive mechanism 1 ranges from 20 mm to 45 mm, the included angle θ between the welding wire 3 and the groove center line 15 is enabled to be equal to θ₁ (70°≤θ₁≤90°), or the included angle θ is adjusted according to the real-time adjustment method described above. The arc swing frequency is adjustable in the range from 2 Hz to 30 Hz, and the time when the arc swings to both sides of the groove for staying is adjustable in the range from 0 ms to 200 ms, respectively. The arc swing angle can be selected in the range from 4° to 16° during constant amplitude swing, and the arc swing angle is adjustable in the range from 7° to 32° during variable amplitude swing, and the embodiments of the arc swing angle are as follows.

Embodiment 5 and embodiment 6 of the arc swing angle for the arc constant amplitude swing: The root gap width g of the groove is 8 mm, the slope angle on one side of the groove is 7°, the welding wire extension is 30 mm, the bent lengths (L or L₂) of the lower part of the conductive rod mechanism are 20 mm and 45 mm, respectively, and when the reserved process gap between the arc and the groove sidewall varies from 2.5 mm to 3.5 mm, the arc swing angle α can be selected in the range from 7° to 5° and from 6.5° to 4°, respectively.

Embodiment 7 and embodiment 8 of the arc swing angle for the arc constant amplitude swing: the root gap width g of the groove is 8 mm, the slope angle on one side of the groove is 13°, the welding wire extension is 30 mm, the bent lengths (L or L₂) of the lower part of the conductive rod mechanism are 20 mm and 45 mm, respectively, and when the reserved process gap between the arc and the groove sidewall varies from 2.5 mm to 3.5 mm, the arc swing angle α can be selected in the range from 14° to 11° and from 10° to 7.5°.

Embodiment 9 and embodiment 10 of the arc swing angle for the arc constant amplitude swing: when the root gap width g of the groove g is 10 mm, the single side slope angle of the groove is 5°, and the welding wire extension is 30 mm, the bent lengths (L or L₂) of the lower part of the conductive rod mechanism are 20 mm and 45 mm, respectively, and when the reserved process gap between the arc and the groove sidewall varies from 2.5 mm and 3.5 mm, the arc swing angle α can be selected in the range from 12° to 8.5° and from 8° to 5.5°, respectively.

Embodiment 11 and embodiment 12 of the arc swing angle for the arc constant amplitude swing: when the root gap width g of the groove is 10 mm, the slope angle on one side of the groove is 11°, and the welding wire extension is 30 mm, the bent lengths (L or L₂) of the lower part of the conductive rod mechanism are 20 mm and 45 mm, respectively, and when the reserved process gap between the arc and the groove sidewall varies from 2.5 mm to 3.5 mm, the arc swing angle α can be selected in the range from 16° to 13° and from 11° to 8.5°, respectively.

Embodiment 1 and embodiment 2 of the arc swing angle for the arc variable amplitude swing: the thickness of the workpiece plate is 15 mm, the welding wire extension is 30 mm, the arc is driven by the welding torch to oscillate back and forth in the groove with an amplitude of 5 mm, and the bent length (L or L₂) of the lower part of the conductive rod mechanism is 20 mm, and the reserved process gap between the arc and the groove sidewall is 2.5 mm.

When the root gap width g of the groove is 8 mm and the slope angle on one side of the groove is 15°, the arc swing angle α is adjustable in the range from 11° to 16° during arc variable amplitude swing, and when the root gap width g of the groove is 10 mm and the slope angle on one side of the groove is 7.5°, the arc swing angle α is adjustable in the range from 11° to 14° during arc variable amplitude swing.

Embodiment 3 and embodiment 4 of the arc swing angle for the arc variable amplitude swing: the thickness of the workpiece plate is 15 mm, the welding wire extension is 30 mm, the arc is driven by the welding torch to oscillate back and forth in the groove with an amplitude of 5 mm, and the bent length (L or L₂) of the lower part of the conductive rod mechanism is 45 mm, and the reserved process gap between the arc and the groove sidewall is 2.5 mm.

When the root gap width g of the groove is 8 mm and the slope angle on one side of the groove is 15°, the arc swing angle α is adjustable in the range from 7° to 11° during arc variable amplitude swing, and when the root gap width g of the groove is 10 mm and the slope angle on one side of the groove is 7.5°, the arc swing angle α is adjustable in the range from 7° to 9° during arc variable amplitude swing.

Embodiment 5 to embodiment 8 of the arc swing angle for the arc variable amplitude swing: the thickness of the workpiece plate is 40 mm, the welding wire extension is 30 mm, the arc is driven by the welding torch to oscillate back and forth in the groove with an amplitude of 20 mm, and the bent length (L or L₂) of the lower part of the conductive rod mechanism is 20 mm, and the reserved process gap between the arc and the groove sidewall is 2.5 mm.

The root gap width g of the groove is 8 mm, and when the slope angle on one side of the groove is 7° and 13°, the arc swing angle α during the arc variable amplitude swing is adjustable in the range from 10° to 19° and from 16° to 32°, respectively. The root gap width g of the groove is 8 mm, and when the slope angle on one side of the groove is 5° and 11°, the arc swing angle α during the arc variable amplitude swing is adjustable in the range from 12° to 18° and from 17° to 31°, respectively.

Embodiments 9 to embodiment 12 of the arc swing angle for the arc variable amplitude swing: the thickness of the workpiece plate is 40 mm, the welding wire extension is 30 mm, the arc is driven by the welding torch to oscillate back and forth in the groove with an amplitude of 20 mm, and the bent length (L or L₂) of the lower part of the conductive rod mechanism is 45 mm, and the reserved process gap between the arc and the groove sidewall is 2.5 mm.

The root gap width g of the groove is 8 mm, and when the slope angle on one side of the groove is 7° and 13°, the arc swing angle α is adjustable in the range from 7° to 13° and from 11° to 21° during the arc variable amplitude swing, respectively. The root gap width g of the groove is 10 mm, and when the slope angle on one side of the groove is 5° and 11°, the arc swing angle α is adjusted in the range from 8° to 12° and from 12° to 20° during the arc variable amplitude swing, respectively.

To sum up, the above-mentioned electro-gas welding method with the swing arc specifically includes the following steps.

\textcircled{1} The welding wire 3 is extended out from the center hole at the lower end of the large-angle bent conductive rod mechanism 1 after passing through the arc swing mechanism 2 to form an included angle θ between the welding wire 3 and the groove center line 15 of the narrow to be welded 9 through the large-angle bent conductive rod mechanism 1 with a bent angle of β, where 30°≤β≤90°.

\textcircled{2} The arc 6 at an end of the welding wire 3 is driven by the welding torch to perform a front and rear linear oscillating 11 along a plate thickness direction in the narrow groove to be welded 9 through the welding torch oscillating mechanism 14, while the arc swing mechanism 2 in the welding torch is driven by the arc motion controller 13 to rotate the large-angle bent conductive rod mechanism 1 to drive the arc 6 to perform a left and right circular-arc-shaped swing 10 around a welding torch center line 2a, so that an arc swing angle is adapted to a gap variation between front and rear sides of the narrow groove to be welded 9, and the arc 6 is swung faster or is continued to be swung at a same frequency during the time when the arc 6 oscillates to a front part and/or a rear part of the narrow groove to be welded 9 for staying, and the arc swing frequency is adjustable in the range from 2 Hz to 30 Hz.

\textcircled{3} The welding torch, a water-cooled copper slider 5 and the welding torch oscillating mechanism 14 are driven by a dragging mechanism to move upwards together at a welding speed V_{w} to enable a molten pool 7 to be forced to solidify and form under an action of a backing 8 and the water-cooled copper slider 5, so that the rapid electro-gas welding is implemented through an swing arc with a variable amplitude and a variable frequency in the narrow groove to be welded 9.

When the above-mentioned narrow groove to be welded 9 is a V-shaped narrow groove 904, the arc 6 is performed the variable amplitude and constant frequency swing with the larger arc swing angle at the front part of groove and smaller arc swing angle at the rear part of the groove, and the constant arc swing frequency, or the arc 6 is performed the variable amplitude and variable frequency swing with the larger arc swing angles at the front part of groove and smaller arc swing angles at the rear part of the groove, and larger arc swing frequency during the time when the arc 6 stays at the front part of groove, or the time when the arc 6 stays at the rear part of groove, or the time when the arc 6 stays at the front part and rear part of the groove; or when the narrow groove to be welded 9 is an I-shaped narrow gap groove 901 or a U-shaped bottom narrow gap groove 902 or a V-shaped bottom narrow gap groove 903 or a V-shaped narrow groove 904, under a constant arc swing angle, the arc 6 is performed the constant amplitude and constant frequency swing with the constant arc swing frequency, or the arc 6 is performed the constant amplitude and variable frequency swing with larger swing frequency during the time when the arc 6 stays at the front part of the groove or the time when the arc 6 stays at the rear part of the groove or the time when the arc 6 stays at the front part and rear part of the groove.

The groove gap width G of the above-mentioned I-shaped narrow gap groove 901 or the U-shaped bottom narrow gap groove 902 or the V-shaped bottom narrow gap groove 903 ranges from 11 mm to 14 mm, and a slope angle on one side of the groove ranges from 0° to 2°. The arc swing angel of constant amplitude swing-is adjustable in the range from 3° to 15°. Alternatively, the root gap width g of the V-shaped narrow groove 904 range from 8 mm to 10 mm, and the slope angle on one side of the groove ranges from 5° to 13°. The arc swing angle is adjustable in the range from 4° to 16° during the constant amplitude swing, and the arc swing angle is adjustable in the range from 7° to 32° during variable amplitude swing.

In the above-mentioned Step \textcircled{1}, the included angle θ formed by the welding wire 3 and the groove center line 15 of the narrow groove to be welded 9 is enabled to be equal to θ₁, where 70°≤θ₁≤90°. Or, in the above-mentioned Step \textcircled{2}, during the time when the arc 6 is driven by the welding torch to oscillate to the front part of the groove for staying, an included angle θ formed by the welding wire 3 and the groove center line 15a of the narrow groove to be welded 9 is enabled to be equal to θ₂ through the welding torch oscillating mechanism 14, where θ₂≥90°. When the arc 6 is driven by the welding torch to oscillate to other positions in the groove, or during the time when the arc 6 is driven by the welding torch to oscillate to the rear part of the groove for staying, an included angle θ formed by the welding wire 3 and the groove center line 15a of the narrow groove to be welded 9 is enabled to be equal to θ₃ through the welding torch oscillating mechanism 14, where θ₃≤90°, and preferably, 90°≤θ₂≤110° and 70°≤θ₃≤90°.

In addition, there are many specific implementation methods and approaches of the present disclosure, and the above mentioned are only the preferred embodiments of the present disclosure. For those of ordinary skill in the art, a plurality of improvements and modifications can be made without departing from the principles of the present disclosure, and these improvements and modifications should also be regarded as the protection scope of the present disclosure. All components that are not specified in this embodiment can be implemented by using the prior art.

1. A rapid electro-gas welding method with a swing arc, wherein a device applied to the method includes a welding torch, an arc motion controller and a welding torch oscillating mechanism, the welding torch includes a large-angle bent conductive rod mechanism and an arc swing mechanism, the method comprising following steps:
step 1: enabling, through the large-angle bent conductive rod mechanism of the welding torch with a bent angle of β, a welding wire to extend out from a center hole at a lower end of the large-angle bent conductive rod mechanism after passing through the arc swing mechanism to form an included angle θ between the welding wire and a groove center line of a narrow groove to be welded;
step 2: driving, by the welding torch, an arc at an end of the welding wire to perform a front and rear linear oscillating along a plate thickness direction in the narrow groove to be welded through the welding torch oscillating mechanism; while driving, by the arc motion controller, the arc swing mechanism in the welding torch to rotate the large-angle bent conductive rod mechanism to drive the arc to perform a left and right circular-arc-shaped swing around a welding torch center line, thereby enabling an arc swing angle to adapt to a gap variation between front and rear sides of the narrow groove to be welded, and enabling the arc to swing faster or to be continued to swing at a same frequency during a time when the arc oscillates to a front part and/or a rear part of the narrow groove to be welded for staying; and
step 3: driving, by a dragging mechanism, the welding torch, a water-cooled copper slider and the welding torch oscillating mechanism to move upwards together at a welding speed V_{w} to enable a molten pool to be forced to solidify and form under an action of a backing and the water-cooled copper slider, thereby implementing the rapid electro-gas welding through a swing arc with a variable amplitude and a variable frequency in the narrow groove to be welded.

2. The rapid electro-gas welding method with the swing arc according to claim 1, wherein the bent angle β of the large-angle bent conductive rod mechanism is satisfied 30°≤β≤90°, and a swing frequency of the arc is adjustable in a range from 2 Hz to 30 Hz.

3. The rapid electro-gas welding method with the swing arc according to claim 1, wherein when the narrow groove to be welded is a V-shaped narrow groove, the arc is performed a variable amplitude and constant frequency swing with larger arc swing angles at a front part of the groove and smaller arc swing angles at a rear part of groove, and constant arc swing frequency, or the arc is performed a variable amplitude and variable frequency swing with larger arc swing angles at the front part of groove and smaller arc swing angles at the rear part the groove, and larger arc swing frequency during the time when the arc stays at the front part and/or the rear part of the groove; or when the narrow groove to be welded is an I-shaped narrow gap groove or a U-shaped bottom narrow gap groove or a V-shaped bottom narrow gap groove or a V-shaped narrow groove, and under a constant arc swing angle, the arc is performed a constant amplitude and constant frequency swing with a constant arc swing frequency, or the arc is performed a constant amplitude and variable frequency swing with larger arc swing frequency during the time when the arc stays at the front part and/or the rear part of the groove.

4. The rapid electro-gas welding method with the swing arc according to claim 3, wherein a groove gap width G of the I-shaped narrow gap groove or the U-shaped bottom narrow gap groove or the V-shaped bottom narrow gap groove ranges from 11 mm to 14 mm, a slope angle on one side of the groove ranges from 0° to 2°, and an arc swing angle of constant amplitude swing is adjustable in a range from 3° to 15°, a root gap width g of the V-shaped narrow groove ranges from 8 mm to 10 mm, and a slope angle on one side of the V-shaped narrow groove ranges from 5° to 13°, the arc swing angle is adjustable in a range from 4° to 16° during a constant amplitude swing, and the arc swing angle is adjustable in a range from 7° to 32° during a variable amplitude swing.

5. The rapid electro-gas welding method with the swing arc according to claim 1, wherein in step 1, the included angle θ formed by the welding wire and the groove center line of the narrow groove to be welded is equal to θ₁, where 70°≤θ₁≤90°.

6. The rapid electro-gas welding method with the swing arc according to claim 1, wherein in step 2, during the time when the arc is driven by the welding torch to oscillate to the front part of the groove for staying, the included angle θ formed by the welding wire and the groove center line of the narrow groove to be welded is enabled to be equal to θ₂ through the welding torch oscillating mechanism, where 90°≤θ₂≤110°; when the arc is driven by the welding torch to oscillate to other positions in the groove or during the time when the arc is driven by the welding torch to swing to the rear part of the groove for staying, the included angle θ formed by the welding wire and the groove center line of the narrow groove to be welded is enabled to be equal to θ₃ through the welding torch oscillating mechanism, where 70°≤θ₃≤90°.

7. A welding torch applied to the rapid electro-gas welding method with the swing arc according to claim 1, the welding torch comprising the large-angle bent conductive rod mechanism and the arc swing mechanism, the arc swing mechanism includes a hollow shaft motor, or an ordinary motor with a transmission pair, wherein the bent angle of the large-angle bent conductive rod mechanism is β, where 30°≤β≤90°, an upper end of the large-angle bent conductive rod mechanism is fixedly connected to a front extending shaft of the hollow shaft motor through a connecting mechanism, or fixedly connected to a driven wheel of the transmission pair of the ordinary motor, and is connected to a welding cable through a cable connector, the welding wire fed by a wire feeder is extended out obliquely from a center hole of the large-angle bent conductive rod mechanism after passing through the hollow shaft of the hollow shaft motor or the driven wheel of the transmission pair.

8. The welding torch according to claim 7, wherein the large-angle bent conductive rod mechanism includes a large-angle bent conductive rod and a straight contact tip fixedly connected at a lower end of the large-angle bent conductive rod, or includes a straight conductive rod and a large-angle bent contact tip fixedly connected at a lower end of the straight conductive rod.

9. The welding torch according to claim 8, wherein an upper end of the large-angle bent conductive rod or an upper end of the straight conductive rod is provided with a connecting flange, and is fixedly connected at a T-shaped end of a T-shaped extending shaft of the hollow shaft motor through the connecting flange.

10. The welding torch according to claim 8, wherein a bent angle of the large-angle bent conductive rod or the large-angle bent contact tip is 30° or 45° or 60°.

11. The welding torch according to claim 8, wherein a bent length of a lower part of the large-angle bent conductive rod mechanism ranges from 40 mm to 50 mm, and a length of the straight contact tip ranges from 20 mm to 30 mm, or a bent length of a lower part of the large-angle bent contact tip ranges from 20 mm to 45 mm.

12. The welding torch according to claim 7, wherein the welding torch further includes a detection mechanism configured to detect the arc swing frequency and an arc swing midpoint, and the detection mechanism is a rotary photoelectric encoder or a photoelectric switch device or an electromagnetic switch device, a rotating component in the detection mechanism is sleeved on a rear extending shaft of the hollow shaft motor or the ordinary motor, or is sleeved on a conductive rod at an upper end of the large-angle bent conductive rod mechanism fixedly connected to the driven wheel of the transmission pair.

13. The welding torch according to claim 12, wherein the photoelectric switch device includes a grating disk and a photoelectric switch, and a circular-arc motion radius of a light path projection point O₁ of the photoelectric switch in a plane of the grating disk is r, then r denotes an operation radius of the grating disk, where
$$r > \frac{d}{2 sin \frac{α}{2}} ,$$
d denotes the light-transmitting groove width of the grating disk, and a denotes an arc swing angle.

14. An application of the welding torch according to claim 7, comprising applying the welding torch to a single-wire electro-gas welding or a twin-wire electro-gas welding; wherein, when the welding torch is applied to the single-wire electro-gas welding, the arc is a single wire arc, and the welding torch is utilized as a welding torch of the single wire arc; when the welding torch is applied to the twin-wire electro-gas welding, the arc is utilized as a front-wire arc, then the front-wire arc is oscillated linearly back and forth and swung reciprocally left and right, whereas the rear-wire arc is neither oscillated nor swung, and the welding torch is utilized as the welding torch of the front-wire arc; or when the welding torch is applied to the twin-wire electro-gas welding, the arc is utilized as the front-wire arc and the rear-wire arc, respectively, then the front-wire arc is oscillated linearly back and forth and swung reciprocally left and right, whereas the rear-wire arc is swung reciprocally left and right but is not oscillated back and forth, and the welding torch is utilized as the welding torch of the front-wire arc and the rear-wire arc, respectively.
